(19) United States
(12) Patent Application Publication
(10) Pub. No.: US 2014/0287298 A1
(43) Pub. Date: Sep. 25, 2014

(54) ALKALINE BATTERY

(71) Applicant: PANASONIC CORPORATION, Osaka (JP)

(72) Inventor: Yasushi Sumihiro, Osaka (JP)

(73) Assignee: PANASONIC CORPORATION, Osaka (JP)

(21) Appl. No.: 14/238,612

(22) PCT Filed: Jul. 26, 2013
(86) PCT No.: PCT/JP2013/004553

§ 371 Date: Feb. 12, 2014

(30) Foreign Application Priority Data
Aug. 28, 2012 (JP) 2012-187184

(51) Int. Cl. H01M 2/06

(52) U.S. Cl. CPC H01M 2/06
USPC 429/181

(57) ABSTRACT

An alkaline battery includes: a battery case; and a sealing unit with which an opening of the battery case is sealed. The sealing unit includes a negative electrode terminal plate, a negative electrode current collector electrically joined to the negative electrode terminal plate, and a gasket. The gasket includes a boss portion having a through hole through which a body portion of the negative electrode current collector is forcibly inserted, an outer portion being in contact with an end of the opening of the battery case, and a connection portion connecting the boss portion to the outer portion. An outside diameter (B) of the body portion is within the range of 1.0-1.6 mm, and a ratio (A/B) of an outside diameter (A) of the boss portion to the outside diameter (B) of the body portion is greater than or equal to 4.

### TECHNICAL FIELD

The present disclosure relates to alkaline batteries, and more particularly to the structure of a sealing unit hermetically sealing an opening of a battery case.

### BACKGROUND ART

A typical alkaline battery includes a battery case accommodating a power-generating element and serving as a positive electrode terminal, and a sealing unit sealing an opening of the battery case. The sealing unit includes a negative electrode terminal plate, a nail-like negative electrode current collector, and a gasket, and the negative electrode current collector has a head portion electrically joined to the negative electrode terminal plate, and a body portion. The gasket has a boss portion having a through hole through which the body portion of the negative electrode current collector is forcibly inserted, an outer portion being in contact with the end of the opening of the battery case, and a connection portion connecting the boss portion to the outer portion. The negative electrode current collector is connected to a central portion of the negative electrode terminal plate generally perpendicularly to the negative electrode terminal plate. The end of the opening of the battery case and the outer portion of the gasket are both bent inward, and bent portions of the battery case and the gasket are crimped onto an outer portion of the negative electrode terminal plate.

In order to prevent an electrolyte from leaking between a negative electrode current collector and a gasket of an alkaline battery having the above structure, various studies have been conducted on the structure of a sealing unit.

For example, PATENT DOCUMENT 1 describes a sealing unit including a gasket made of a specific material and satisfying the relationship defined by A/B=1.02 through 1.12 and C/A=1.8 through 3.2, where A represents the diameter of a body portion of a negative electrode current collector, B represents the diameter of a through hole of a boss portion of the gasket, and C represents the outside diameter of the boss portion. Such a sealing unit reduces electrolyte leakage between the negative electrode current collector and the gasket.

### CITATION LIST

### Patent Document

### PATENT DOCUMENT 1: Japanese Patent No. 4944482

### SUMMARY OF THE INVENTION

### Technical Problem

However, in the step of electrically connecting a head portion of a negative electrode current collector to a negative electrode terminal plate, variations in the step or trouble during the step may cause the negative electrode current collector to be connected obliquely to the negative electrode terminal plate without being perpendicularly connected thereto, or may cause the negative electrode current collector to be connected to a portion of the negative electrode terminal plate located outward from the center thereof. In such cases, when the end of an opening of a battery case is crimped onto an outer portion of the negative electrode terminal plate, a gap is formed between the negative electrode current collector and the gasket as illustrated in FIG. 2A below, and consequently an electrolyte leaks through the gap.

The present disclosure has been made to solve the problem, and it is an object of the present disclosure to provide an alkaline battery that prevents the formation of the gap between a negative electrode current collector and a gasket and reduces electrolyte leakage even in a situation where the negative electrode current collector is connected obliquely to a negative electrode terminal plate without being perpendicularly connected thereto, or even in a situation where the negative electrode current collector is connected to a portion of the negative electrode terminal plate located outward from the center thereof.

### Solution to the Problem

In order to achieve the object, the present disclosure is directed to an alkaline battery including: a battery case; and a sealing unit with which an opening of the battery case is sealed. The sealing unit includes a negative electrode terminal plate, a negative electrode current collector electrically joined to the negative electrode terminal plate, and a gasket. The gasket includes a boss portion having a through hole through which a body portion of the negative electrode current collector is forcibly inserted, an outer portion being in contact with an end of the opening of the battery case, and a connection portion connecting the boss portion to the outer portion. An outside diameter (B) of the body portion of the negative electrode current collector is within the range of 1.0-1.6 mm, and a ratio (A/B) of an outside diameter (A) of the boss portion to the outside diameter (B) of the body portion of the negative electrode current collector is greater than or equal to 4.

### Advantages of the Invention

According to the present disclosure, even in a situation where the negative electrode current collector is connected obliquely to the negative electrode terminal plate, or even in a situation where the negative electrode current collector is connected to a portion of the negative electrode terminal plate located outward from the center thereof, when the end of the opening of the battery case is crimped onto an outer portion of the negative electrode terminal plate, the formation of the gap between the negative electrode current collector and the gasket can be prevented, thereby reducing electrolyte leakage.

### BRIEF DESCRIPTION OF THE DRAWINGS

FIG. 1 is a half sectional view illustrating the configuration of an alkaline battery according to an embodiment of the present disclosure.

FIG. 2A is a partial cross-sectional view of an alkaline battery for explaining a problem to be solved by the present invention, and FIG. 2B is a partial cross-sectional view of an alkaline battery for explaining an advantage of the embodiment of the present disclosure.

### DESCRIPTION OF EMBODIMENTS

An embodiment of the present disclosure will be described hereinafter with reference to the drawings. The present disclosure is not limited to the following embodiment.

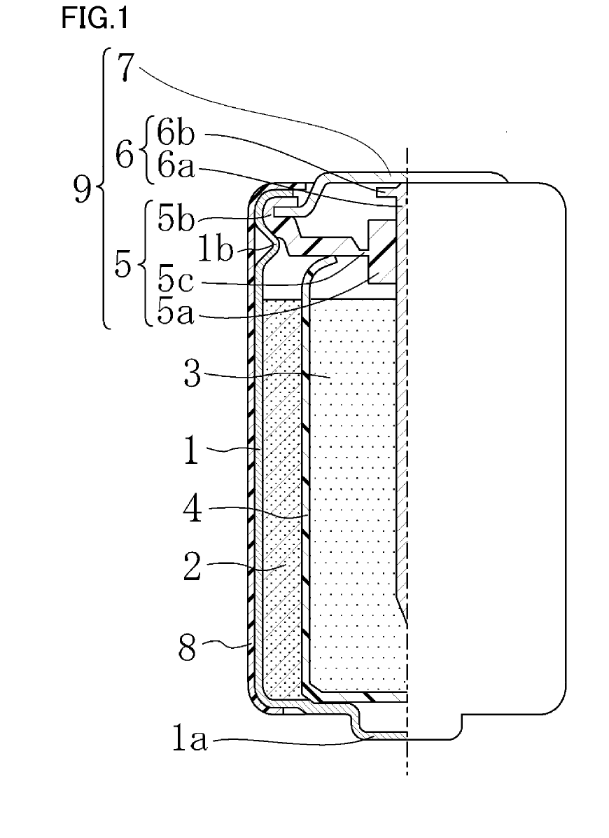

FIG. 1 is a half sectional view illustrating the configuration of an alkaline battery according to the embodiment of the present disclosure.

As illustrated in FIG. 1, a hollow cylindrical positive electrode mixture 2 is housed in a closed-end cylindrical battery case 1 serving also as a positive electrode current collector. A bottom portion of the battery case 1 includes a positive electrode terminal la. A gelled negative electrode 3 is placed in a hollow portion of the positive electrode mixture 2 with a closed-end cylindrical separator 4 interposed therebetween. An opening of the battery case 1 is sealed with a sealing unit 9.

The sealing unit 9 includes a nail-like negative electrode current collector 6 having a body portion 6a and a head portion 6b, a negative electrode terminal plate 7 being in contact with the negative electrode current collector 6, and a gasket 5. The gasket 5 includes a boss portion 5a, an outer portion 5b, and a connection portion connecting the boss portion 5a to the outer portion 5b. The body portion 6a of the negative electrode current collector 6 is inserted into the gelled negative electrode 3.

The negative electrode terminal plate 7 has a hole (not shown) through which gas in the battery is released to outside the battery. When the internal pressure of the battery has abnormally increased, a thin part 5c of the connection portion of the gasket 5 breaks, and the gas can be released through the hole to outside the battery.

The body portion 6a of the negative electrode current collector 6 is inserted through a through hole formed in the boss portion 5a, and the head portion 6b of the negative electrode current collector 6 is electrically connected to the negative electrode terminal plate 7 by, for example, welding. The end of the opening of the battery case 1 and the outer portion 5b of the gasket 5 are both bent inward, and bent portions of the battery case 1 and the gasket 5 are crimped onto an outer portion of the negative electrode terminal plate 7. An outer surface of the battery case 1 is coated with an exterior label 8.

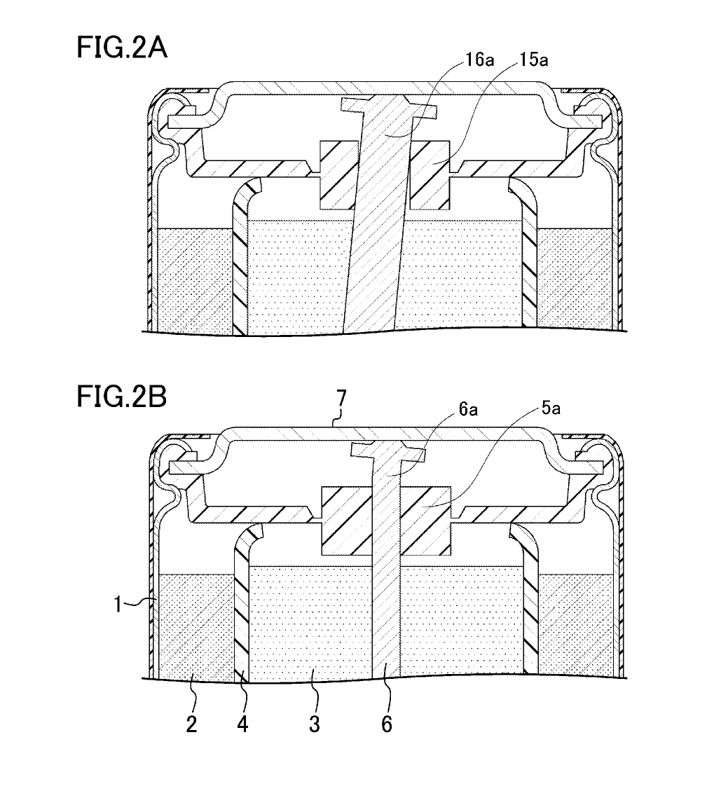

A problem to be solved by the present invention and an advantage of the present invention will be described hereinafter with reference to FIGS. 2A and 2B. FIG. 2A is a partial cross-sectional view of an alkaline battery for explaining the problem to be solved by the present invention, and FIG. 2B is a partial cross-sectional view of an alkaline battery for explaining the advantage of the embodiment of the present disclosure.

In the step of electrically connecting a head portion of a negative electrode current collector to a negative electrode terminal plate, variations in the step or trouble during the step may cause the negative electrode current collector to be connected obliquely to the negative electrode terminal plate without being perpendicularly connected thereto, or may cause the negative electrode current collector to be connected to a portion of the negative electrode terminal plate located outward from the center thereof.

In such cases, when the end of an opening of a battery case is crimped onto an outer portion of a negative electrode terminal plate, a gap is formed between a body portion 16a of a negative electrode current collector and a boss portion 15a of a gasket as illustrated in FIG. 2A. This facilitates causing an electrolyte in the battery to leak through the gap.

To address this problem, in a sealing unit 9 that includes a negative electrode terminal plate 7, a negative electrode current collector 6 electrically joined to the negative electrode terminal plate 7, and a gasket 5, the outside diameter (B) of a body portion 6a of the negative electrode current collector 6 may be within the range of 1.0-1.6 mm, and the ratio (A/B) of the outside diameter (A) of a boss portion 5a of the gasket 5 to the outside diameter (B) of the body portion 6a of the negative electrode current collector 6 may be greater than or equal to four.

With this configuration, when the sealing unit 9 is crimped with a battery case 1, the boss portion 5a of the gasket 5, which is sufficiently thicker than the outside diameter of the body portion 6a of the negative electrode current collector 6, corrects for the inclination and displacement of the negative electrode current collector 6 as illustrated in FIG. 2B. This correction prevents the formation of the gap between the body portion 6a of the negative electrode current collector 6 and the boss portion 5a of the gasket 5, thereby reducing electrolyte leakage.

When the outside diameter (B) of the body portion 6a of the negative electrode current collector 6 is less than 1.0 mm, current is inadequately collected during the battery discharge, and the discharge performance decreases. When the outside diameter of the body portion 6a of the negative electrode current collector 6 is greater than 1.6 mm, the rigidity of the negative electrode current collector 6 increases, and the negative electrode current collector 6 is resistant to deformation for the correction. Here, a state where the negative electrode current collector 6 undergoes deformation for the correction corresponds to a state where a portion of the body portion 6a of the negative electrode current collector 6 inserted through the boss portion 5a is kept in a normal position (at which the negative electrode current collector 6 is located on a central portion of the negative electrode terminal plate 7, and is perpendicular to the negative electrode terminal plate 7), and a portion of the body portion 6a exposed from the boss portion 5a to the negative electrode terminal plate 7 is obliquely inclined (or displaced outward).

In contrast, when the ratio (A/B) of the outside diameter (A) of the boss portion 5a to the outside diameter (B) of the body portion 6a of the negative electrode current collector 6 is less than four, the force with which the boss portion 5a tightens the body portion 6a of the negative electrode current collector 6 decreases, and the negative electrode current collector 6 is, therefore, resistant to deformation for the correction.

It is not preferable that the outside diameter (A) of the boss portion 5a of the gasket 5 is greater than 14 mm, because when a sealing unit is disposed at the end of the opening of the battery case, the gelled negative electrode 3 may overflow the separator 4 to cause an internal short circuit.

The ratio (B/C) of the outside diameter (B) of the body portion 6a of the negative electrode current collector 6 to the diameter (C) of the through hole of the boss portion 5a is preferably greater than 1.05, because the force with which the boss portion 5a tightens the body portion 6a of the negative electrode current collector 6 further increases to improve the resistance to electrolyte leakage.

The length of the boss portion 5a is preferably greater than or equal to 5.0 mm, because the force with which the boss portion 5a tightens the body portion 6a of the negative electrode current collector 6 further increases to improve the resistance to electrolyte leakage.

The negative electrode current collector 6 is preferably made of copper, or brass containing 60% or more copper by mass. With this configuration, the hardness of the negative electrode current collector 6 is low, and the negative electrode current collector 6 tends to undergo deformation for the correction.

When the thickness of the thin part 5c of the gasket 5 is greater than or equal to 0.25 mm, the negative electrode current collector 6 more easily undergoes deformation for the correction. The reason for this is that when the boss portion 5a corrects for the inclination and displacement of the negative electrode current collector 6, the inclination of the boss portion 5a can be reduced.

In order to improve the strength of the sealing unit 9, a ring-shaped metallic washer may be inserted between the negative electrode terminal plate 7 and the connection portion of the gasket 5. However, when no ring-shaped washer is inserted therebetween, the outer portion of the negative electrode terminal plate 7 is more tightly crimped with the gasket 5. This allows the negative electrode current collector 6 to appropriately undergo deformation for the correction.

Among AA batteries, AAA batteries, C batteries, D batteries, and N batteries, C alkaline batteries and D alkaline batteries both having a large product size more easily gain the advantage of the present invention, because the degree of inclination or displacement of a negative electrode current collector increases in proportion to the product size.

Examples of the present disclosure will be described in detail hereinafter. The present disclosure is not limited to the examples. Various changes and modifications may be made without departing from the scope of the present invention.

### EXAMPLES

A D alkaline battery similar to that illustrated in FIG. 1 was fabricated through the following steps 1-4.

<<Step 1>> Fabrication of Positive Electrode Mixture

Electrolytic manganese dioxide powder with an average particle size of 35 μm and graphite powder with an average particle size of 15 μm were mixed in a mass ratio of 93:7. The resultant mixture and an alkaline electrolyte solution were mixed in a mass ratio of 100:3, were fully stirred, and then, were compressed into positive electrode mixture flakes. Note that an aqueous alkaline solution containing 34% potassium hydroxide by mass and 2% zinc oxide by mass was used as the alkaline electrolyte solution. Subsequently, the positive electrode mixture flakes were pulverized into granules, and the granules were classified using a sieve. Among the granules, 10-100 mesh granules were press-molded into a hollow cylindrical shape to obtain a pellet-shaped positive electrode mixture 2.

<<Step 2>> Preparation of Gelled Negative Electrode

Sodium polyacrylate powder that serves as a gelling agent, an aqueous alkaline solution that serves as an alkaline electrolyte solution and is identical with the aqueous alkaline solution described above, and zinc alloy powder that serves as a negative electrode active material were mixed in a mass ratio of 0.8:36.2:63.0 to obtain a gelled negative electrode 3. Zinc alloy powder used as the zinc alloy power contained 0.020% indium by mass, 0.010% bismuth by mass, and 0.010% aluminum by mass, had a volume mean particle size of 60 μm, and contained 10% particles each having a size of 75 μm or less.

<<Step 3>> Fabrication of Sealing Unit

A gasket 5 was prepared by injection-molding nylon 6,6. The height of a boss portion 5a of the gasket 5 is 3.0 mm, the diameter of a through hole of the boss portion 5a is 1.36 mm, the thickness of a thin part 5c of the gasket 5 is 0.20 mm, and the boss portion 5a has a predetermined outside diameter as illustrated in Table 1 below.

A 0.6-mm-thick nickel plated steel plate was pressed into a predetermined shape with predetermined dimensions to obtain a negative electrode terminal plate 7.

Brass containing 50% copper by mass was pressed into a nail shape by a known process, and then tin plating was performed on the surface of the brass to obtain a negative electrode current collector 6 having an entire length of 36.0 mm and including a body portion 6a with a predetermined outside diameter illustrated in Table 1 below.

Sealing units 9 including the same gasket 5, the same negative electrode terminal plate 7, and the same negative electrode current collector 6 (the same design conditions) were fabricated under three types of conditions of electric welding between the negative electrode terminal plate 7 and the negative electrode current collector 6 to examine the advantage of the present invention.

Under the first type of conditions, a sealing unit (oblique welding assumed sample) was fabricated with consideration given to variations in fabrication to evaluate the electrolyte leakage resistance described below. A head portion of a negative electrode current collector 6 of the sealing unit was electrically welded obliquely to a flat portion of a central portion of a negative electrode terminal plate 7 of the sealing unit such that the angle between the flat portion of the central portion of the negative electrode terminal plate 7 and the negative electrode current collector 6 was 85°.

Under the second type of conditions, a sealing unit (apart-from-center welding assumed sample) was fabricated. A negative electrode current collector 6 of the sealing unit was electrically welded perpendicularly to a flat portion of a central portion of a negative electrode terminal plate 7 of the sealing unit such that the negative electrode current collector 6 was displaced 0.5 mm outward from the center of the flat portion.

Under the third type of conditions, a sealing unit (normal welding assumed sample) was fabricated to evaluate properties except the electrolyte leakage resistance. A negative electrode current collector 6 of the sealing unit was electrically welded to the center of a flat portion of a central portion of a negative electrode terminal plate 7 of the sealing unit such that the flat portion and the negative electrode current collector 6 are perpendicular to each other.

<<Step 4>> Assembly of Alkaline Battery

Two positive electrode mixtures 2 each having a weight of 34.0 g were inserted into a battery case 1, and pressed with a pressing jig into close contact with the inner wall of the battery case 1. A closed-end cylindrical separator 4 was placed inside the positive electrode mixtures 2. An alkaline electrolyte solution weighing 11.0 g was injected into the separator 4. After a lapse of a predetermined period, the internal space of the separator 4 was filled with 35.0 g of a gelled negative electrode 3.

Nonwoven fabric mainly containing polyvinyl alcohol fibers and rayon fibers was used as the separator 4. The battery case 1 includes a step portion 1b near the end of its opening, and a sealing unit was disposed at the end of the opening of the battery case 1 such that a horizontal portion of the sealing unit was supported on the step portion 1b. In this case, a portion of a negative electrode current collector 6 was inserted into the gelled negative electrode 3. Thereafter, the end of the opening of the battery case 1 and an outer portion 5b of a gasket 5 were both bent inward, and the opening of the battery case 1 was sealed by crimping bent portions of the battery case 1 and the gasket 5 onto an outer portion of a negative electrode terminal plate 7. An outer surface of the battery case 1 was coated with the external label 8.

The following evaluations were made on alkaline batteries each including one of sealing units (P-1-P-13) illustrated in Table 1.

### <<Evaluation of Electrolyte Leakage Resistance>>

The alkaline batteries each including the oblique welding assumed sample and the alkaline batteries each including the apart-from-center welding assumed sample were prepared with consideration given to variations in fabrication. The alkaline batteries, 10 each, were stored for six months in an environment of a temperature of 45° C. at which the batteries can be typically used, and the number of the batteries from which an electrolyte leaked was examined after the storage. Batteries from which an electrolyte did not leak in this environment are highly reliable alkaline batteries having a practically adequate electrolyte leakage resistance. It was visually checked whether or not an electrolyte leaked from the batteries.

In order to examine more highly reliable alkaline batteries as necessary, the alkaline batteries, 10 each, were stored for three months in a more severe environment of a temperature of 60° C. and a humidity of 90% (90RH %), and the number of the batteries from which an electrolyte leaked was examined after the storage. It was visually checked whether or not an electrolyte leaked from the batteries.

<<Evaluation of Discharge Performance>>

The alkaline batteries each including the normal welding assumed sample, five each, were prepared, and the duration of each of the five alkaline batteries until the battery is discharged to 0.9 V at a resistance load of 2.2Ω in an environment of a constant temperature of 20±2° C. was measured. The duration in Table 1 shows the average of the durations of the five batteries (in hours).

<<Evaluation of Internal Short-Circuit>>

When the sealing units corresponding to normal welding assumed samples, 10 each, were disposed at the end of an opening of a battery case, batteries in each of which a gelled negative electrode overflowed a separator to generate heat correspond to batteries in each of which an internal short circuit occurs, and the number of such batteries was examined.

Table 1 illustrates the evaluation results. An electrolyte leaked from batteries each including the sealing unit P-6 and batteries each including the sealing unit P-7 after the batteries had been stored for six months in an environment of 45° C. Here, the sealing units P-6 and P-7 each included a negative electrode current collector having a body portion with an outside diameter of 1.8 mm. An electrolyte leaked also from batteries including the sealing unit P-3 and batteries including the sealing unit P-9 after the batteries had been stored for six months in an environment of 45° C. In each of the sealing units P-3 and P-9, the ratio (A/B) of the outside diameter (A) of a boss portion of a gasket to the outside diameter (B) of a body portion of a negative electrode current collector was less than four.

In contrast, an electrolyte did not leak from batteries each including any one of the sealing units P-1, P-2, P-4, P-5, P-8, P-10, and P-11 after the batteries had been stored for six months in an environment of 45° C. In each of the sealing units P-1, P-2, P-4, P-5, P-8, P-10, and P-11, the outside diameter (B) of a body portion of a negative electrode current collector was within the range of 1.0-1.6 mm, and the ratio (A/B) of the outside diameter (A) of a boss portion of a gasket to the outside diameter (B) of a body portion of a negative electrode current collector was greater than or equal to four.

Batteries each including the sealing unit P-12 and batteries each including the sealing unit P-13 were not capable of adequately collecting current, resulting in decreased discharge performance. Each of the sealing units P-12 and P-13 included a negative electrode current collector having a body portion with an outside diameter (B) of 0.8 mm.

The above-described results show that even in a situation where a negative electrode current collector is connected obliquely to a negative electrode terminal plate, or even in a situation where a negative electrode current collector is connected to a portion of a negative electrode terminal plate located outward from the center thereof, when the outside diameter (B) of a body portion of the negative electrode current collector is within the range of 1.0-1.6 mm, and the ratio (A/B) of the outside diameter (A) of a boss portion of a gasket to the outside diameter (B) of the body portion of the negative electrode current collector is greater than or equal to four, such settings can reduce electrolyte leakage caused by crimping the end of an opening of a battery case onto an outer portion of the negative electrode terminal plate.

An internal short circuit occurred in each of batteries each including the sealing unit P-5 and batteries each including the sealing unit P-11 when the corresponding sealing unit was disposed at the end of an opening of a battery case. The sealing units P-5 and P-11 each included a gasket having a boss portion with an outside diameter (A) of 16 mm. The reason for the occurrence of the internal short circuit may be that in a situation where the outside diameter (A) of the boss portion was too large, when the sealing unit was disposed at the end of the opening of the battery case, a portion of the boss portion was immersed in the gelled negative electrode, and the gelled negative electrode overflowed and then flowed into a positive electrode.

TABLE 1

| | | | | ELECTROLYTE LEAKAGE | | | |
|---|---|---|---|---|---|---|---|
| | SEALING UNIT | | | RESISTANCE | | | |
| | | OUTSIDE DIAMETER | | 45° C. STORED FOR 6 MONTHS | | | |
| | DIAMETER A | B OF BODY | | | APART- | DISCHARGE | INTERNAL |
| | OF BOSS | PORTION OF | | | FROM- | PERFORMANCE | SHORT-CIRCUIT |
| | PORTION OF | NEGATIVE CURRENT | | OBLIQUE | CENTER | NORMAL | NORMAL |
| | GASKET (mm) | COLLECTOR (mm) | A/B | WELDING | WELDING | WELDING | WELDING |
| P-1 | 9.0 | 1.4 | 6.4 | 0 | 0 | 18.2 | 0 |
| P-2 | 8.0 | 1.6 | 5.0 | 0 | 0 | 18.2 | 0 |
| P-3 | 6.0 | 1.6 | 3.8 | 2 | 3 | 18.2 | 0 |
| P-4 | 14.0 | 1.6 | 8.8 | 0 | 0 | 18.2 | 0 |
| P-5 | 16.0 | 1.6 | 10.0 | 0 | 0 | 18.2 | 8 |
| P-6 | 8.0 | 1.8 | 4.4 | 5 | 7 | 18.2 | 0 |
| P-7 | 14.0 | 1.8 | 7.8 | 4 | 4 | 18.2 | 0 |
| P-8 | 4.0 | 1.0 | 4.0 | 0 | 0 | 18.2 | 0 |
| P-9 | 3.0 | 1.0 | 3.0 | 2 | 2 | 18.2 | 0 |
| P-10 | 14.0 | 1.0 | 14.0 | 0 | 0 | 18.2 | 0 |
| P-11 | 16.0 | 1.0 | 16.0 | 0 | 0 | 18.2 | 4 |
| P-12 | 4.0 | 0.8 | 5.0 | 0 | 0 | 16.5 | 0 |
| P-13 | 14.0 | 0.8 | 17.5 | 0 | 0 | 16.5 | 0 |

Next, the diameter of a through hole of a gasket was studied. Alkaline batteries were fabricated through steps identical with the steps 1-4 except that the outside diameter (B) of a body portion of each of negative electrode current collectors was fixed at 1.4 mm, and that one of the alkaline batteries included a gasket having a through hole with a diameter (C) of 1.36 mm, another one thereof included a gasket having a through hole with a diameter (C) of 1.33 mm, and the other one thereof included a gasket having a through hole with a diameter (C) of 1.30 mm.

Table 2 illustrates the results of evaluating the electrolyte leakage resistances of the alkaline batteries. An electrolyte leaked from the one of the alkaline batteries including the sealing unit P-1 after the one of the alkaline batteries had been stored for three months in an environment of a temperature of 60° C. and a humidity of 90%, i.e., under more severe conditions than the conditions on which batteries are typically used. In the sealing unit P-1, the ratio (B/C) of the outside diameter (B) of the body portion of the negative electrode current collector to the diameter (C) of the through hole of the gasket was 1.03.

In contrast, an electrolyte did not leak from each of alkaline batteries each including the sealing unit Q-1 and alkaline batteries each including the sealing unit Q-2 even after the alkaline batteries had been stored for three months in an environment of a temperature of 60° C. and a humidity of 90%. In each of the sealing units Q-1 and Q-2, the ratio (B/C) of the outside diameter (B) of the body portion of the negative electrode current collector to the diameter (C) of the through hole of the gasket was greater than or equal to 1.05.

The above-described results show that when the ratio (B/C) of the outside diameter (B) of the body portion of the negative electrode current collector to the diameter (C) of the through hole of the gasket is greater than 1.05, such a ratio can further improve the electrolyte leakage resistance.

TABLE 2

| | | | | ELECTROLYTE LEAKAGE RESISTANCE | | | |
|---|---|---|---|---|---|---|---|
| | SEALING UNIT | | | 45° C. | | 60° C.~90% RH | |
| | | OUTSIDE DIAMETER | | STORED FOR 6 MONTHS | | STORED FOR 3 MONTHS | |
| | DIAMETER C | B OF BODY | | | APART- | | APART- |
| | OF THROUGH | PORTION OF | | | FROM- | | FROM- |
| | HOLE OF | NEGATIVE CURRENT | | OBLIQUE | CENTER | OBLIQUE | CENTER |
| | GASKET (mm) | COLLECTOR (mm) | B/C | WELDING | WELDING | WELDING | WELDING |
| P-1 | 1.36 | 1.4 | 1.03 | 0 | 0 | 1 | 2 |
| Q-1 | 1.33 | 1.4 | 1.05 | 0 | 0 | 0 | 0 |
| Q-2 | 1.30 | 1.4 | 1.08 | 0 | 0 | 0 | 0 |

Next, the copper content in the negative electrode current collector 6 was studied. Alkaline batteries were fabricated through steps identical with the steps 1-4 except that one of the alkaline batteries included a negative electrode current collector having a copper content of 50% by mass, another one thereof included a negative electrode current collector having a copper content of 60% by mass, and the other one thereof included a negative electrode current collector having a copper content of 100% by mass.

Table 3 illustrates the results of evaluating the electrolyte leakage resistances of the alkaline batteries. An electrolyte leaked from the one of the alkaline batteries including the sealing unit P-1 after the one of the alkaline batteries had been stored for three months in an environment of a temperature of 60° C. and a humidity of 90%, i.e., under more severe conditions than the conditions on which batteries are typically used. The sealing unit P-1 included a negative electrode current collector having a copper content of 50% by mass.

In contrast, an electrolyte did not leak from the other alkaline batteries each including a corresponding one of sealing units R-1 and R-2 even after the other alkaline batteries had been stored for three months in an environment of a temperature of 60° C. and a humidity of 90%. The sealing units R-1 and R-2 each included a negative electrode current collector having a copper content of greater than or equal to 60% by mass.

The above-described results show that the use of a negative electrode current collector having a copper content of greater than or equal to 60% by mass can further improve the electrolyte leakage resistance.

TABLE 3

| | COPPER | ELECTROLYTE LEAKAGE RESISTANCE | | | |
|---|---|---|---|---|---|
| | CONTENT OF | 45° C. | | 60° C.-90% RH | |
| | NEGATIVE | STORED FOR 6 MONTHS | | STORED FOR 3 MONTHS | |
| | CURRENT | | APART-FROM- | | APART-FROM- |
| | COLLECTOR | OBLIQUE | CENTER | OBLIQUE | CENTER |
| | (% BY MASS) | WELDING | WELDING | WELDING | WELDING |
| P-1 | 50 | 0 | 0 | 1 | 2 |
| R-1 | 60 | 0 | 0 | 0 | 0 |
| R-2 | 100 | 0 | 0 | 0 | 0 |

Next, the height of a boss portion of a gasket was studied. Alkaline batteries were fabricated through steps identical with the steps 1-4 except that one of the alkaline batteries included a gasket having a boss portion with a height of 3.0 mm, another one thereof included a gasket having a boss portion with a height of 5.0 mm, and the other one thereof included a gasket having a boss portion with a height of 8.0 mm.

Table 4 illustrates the results of evaluating the electrolyte leakage resistance of the alkaline batteries. An electrolyte leaked from the one of the alkaline batteries including the sealing unit P-1 after the one of the alkaline batteries had been stored for three months in an environment of a temperature of 60° C. and a humidity of 90%. The sealing unit P-1 included a gasket having a boss portion with a height of 3.0 mm.

In contrast, an electrolyte did not leak from the other alkaline batteries each including a corresponding one of sealing units S-1 and S-2 even after the other alkaline batteries had been stored for three months in an environment of a temperature of 60° C. and a humidity of 90%. The sealing units S-1 and S-2 each included a gasket having a boss portion with a height of greater than or equal to 5.0 mm.

The above-described results show that when the height of the boss portion is greater than or equal to 5.0 mm, such a height can further improve the electrolyte leakage resistance.

TABLE 4

| | HEIGHT | ELECTROLYTE LEAKAGE RESISTANCE | | | |
|---|---|---|---|---|---|
| | OF | 45° C. STORED | | 60° C.-90% RH | |
| | BOSS | FOR 6 MONTHS | | STORED FOR 3 MONTHS | |
| | PORTION | | APART- | | APART- |
| | OF | | FROM- | | FROM- |
| | GASKET | OBLIQUE | CENTER | OBLIQUE | CENTER |
| | (mm) | WELDING | WELDING | WELDING | WELDING |
| P-1 | 3.0 | 0 | 0 | 1 | 2 |
| S-1 | 5.0 | 0 | 0 | 0 | 0 |
| S-2 | 8.0 | 0 | 0 | 0 | 0 |

Next, the thickness of a thin part of a gasket was studied. Alkaline batteries were fabricated through steps identical with the steps 1-4 except that one of the alkaline batteries included a gasket having a thin part with a thickness of 0.20 mm, another one thereof included a gasket having a thin part with a thickness of 0.25 mm, and the other one thereof included a gasket having a thin part with a thickness of 0.30 mm.

Table 5 illustrates the results of evaluating the electrolyte leakage resistances of the alkaline batteries. An electrolyte leaked from the one of the alkaline batteries including the sealing unit P-1 after the one of the alkaline batteries had been stored for three months in an environment of a temperature of 60° C. and a humidity of 90%. The sealing unit P-1 included a gasket having a thin part with a thickness of 0.20 mm.

In contrast, an electrolyte did not leak from the other alkaline batteries each including a corresponding one of sealing units T-1 and T-2 even after the other alkaline batteries had been stored for three months in an environment of a temperature of 60° C. and a humidity of 90%. The sealing units T-1 and T-2 each included a gasket having a thin part with a thickness of greater than or equal to 0.25 mm.

The above-described results show that when the thickness of a thin part of a gasket is greater than or equal to 0.25 mm, such a thickness can further improve the electrolyte leakage resistance.

TABLE 5

| | | ELECTROLYTE LEAKAGE RESISTANCE | | | |
|---|---|---|---|---|---|
| | | 45° C. | | 60° C.-90% RH | |
| | THICKNESS OF | STORED FOR 6 MONTHS | | STORED FOR 3 MONTHS | |
| | THIN PART OF | | APART-FROM- | | APART-FROM- |
| | GASKET | OBLIQUE | CENTER | OBLIQUE | CENTER |
| | (mm) | WELDING | WELDING | WELDING | WELDING |
| P-1 | 0.20 | 0 | 0 | 1 | 2 |
| T-1 | 0.25 | 0 | 0 | 0 | 0 |
| T-2 | 0.30 | 0 | 0 | 0 | 0 |

While, in the examples, D alkaline batteries were illustrated, alkaline batteries having other sizes, such as AA batteries, AAA batteries, C batteries, and N batteries also provide the advantage of the present invention similar to the above-described advantage.

### INDUSTRIAL APPLICABILITY

An alkaline battery of the present disclosure has high reliability, and is suitable for use in, for example, electronic devices and mobile equipment.

### DESCRIPTION OF REFERENCE CHARACTERS

1 BATTERY CASE
1a POSITIVE ELECTRODE TERMINAL
1b STEP PORTION
2 POSITIVE ELECTRODE MIXTURE
3 GELLED NEGATIVE ELECTRODE
4 SEPARATOR
5 GASKET
5a, 15a BOSS PORTION
5b OUTER PORTION
5c THIN PART
6 NEGATIVE ELECTRODE CURRENT COLLECTOR
6a, 16a BODY PORTION
6b HEAD PORTION
7 NEGATIVE ELECTRODE TERMINAL PLATE
8 EXTERIOR LABEL
9 SEALING UNIT

1. An alkaline battery comprising:
a battery case; and
a sealing unit with which an opening of the battery case is sealed, wherein
the sealing unit includes
a negative electrode terminal plate,
a negative electrode current collector electrically joined to the negative electrode terminal plate, and
a gasket,
the gasket includes
a boss portion having a through hole through which a body portion of the negative electrode current collector is forcibly inserted,
an outer portion being in contact with an end of the opening of the battery case, and
a connection portion connecting the boss portion to the outer portion,
an outside diameter (B) of the body portion of the negative electrode current collector is within the range of 1.0-1.6 mm, and
a ratio (A/B) of an outside diameter (A) of the boss portion to the outside diameter (B) of the body portion of the negative electrode current collector is greater than or equal to 4.

2. The alkaline battery of claim 1, wherein the outside diameter (A) of the boss portion is less than or equal to 14 mm.

3. The alkaline battery of claim 1, wherein
a ratio (B/C) of the outside diameter (B) of the body portion of the negative electrode current collector to a diameter (C) of the through hole of the gasket is greater than or equal to 1.05.

4. The alkaline battery of claim 1, wherein
the negative electrode current collector is made of copper or brass having a copper content of greater than or equal to 60% by mass.

5. The alkaline battery of claim 1, wherein
a length of the boss portion is greater than or equal to 5.0 mm.

6. The alkaline battery of claim 1, wherein
the connection portion of the gasket includes a safety valve that is a thin part, and
a thickness of the thin part is greater than or equal to 0.25 mm.

7. The alkaline battery of claim 1, wherein the alkaline battery is a C or D battery.
